(19) United States
(12) Patent Application Publication
(10) Pub. No.: US 2006/0113908 A1
(43) Pub. Date: Jun. 1, 2006

(54) Plasma display panel

(75) Inventor: Tae-Ho Lee, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/281,681

(22) Filed: Nov. 18, 2005

(30) Foreign Application Priority Data
Nov. 30, 2004 (KR) 10-2004-0098966

(51) Int. Cl. H01J 17/49

(52) U.S. Cl. 313/582

(57) ABSTRACT

A plasma display panel including a first substrate and a second substrate facing each other and including a display region for displaying images and a non-display region located at a periphery of the display region, a barrier rib arranged between the first substrate and the second substrate and forming discharge cells, an address electrode arranged between the first substrate and the second substrate and extending along a first direction, and a first electrode and a second electrode arranged in the discharge cells and extending along a second direction. The line width of the barrier rib formed in the display region is different from the line width of the barrier rib formed in the non-display region.

### CROSS-REFERENCE TO RELATED APPLICATION

This application claims priority to and the benefit of Korean Patent Application No. 10-2004-0098966, filed on Nov. 30, 2004, which is hereby incorporated by reference for all purposes as if fully set forth herein.

### BACKGROUND OF THE INVENTION

1. Field of the Invention

The present invention relates to a plasma display panel, and more particularly, to barrier ribs of a plasma display panel.

2. Discussion of the Background

Generally, a plasma display panel (PDP) displays images using gas discharge, and it has superior display features in terms of display capacity, luminance, contrast, residual image, and viewing angle.

The PDP includes a barrier rib arranged between a front substrate and a rear substrate that are sealed together. The front substrate typically includes display electrodes, and the rear substrate typically includes address electrodes, the barrier rib, and a phosphor layer. The barrier rib partitions discharge cells, which are filled with a discharge gas.

The barrier rib may be formed through sandblasting, and the phosphor layer may be formed by a printing method.

The printing method may include arranging a screen mask on the barrier rib, and applying a phosphor paste, which passes through the screen mask, to the sides of the barrier rib by applying pressure to the phosphor paste on the screen mask.

The PDP includes a display region, on which images are displayed, and a non-display region, on which images are not displayed. In such a PDP, some barrier ribs are formed entirely within the non-display region, while others are formed in both the non-display and display regions. However, the barrier ribs have the same line width.

For the purpose of preventing noise and pollution in an exhaust process, or for preventing the barrier rib from shrinking in a baking process, the barrier ribs that are formed in an outermost region of the non-display region may be wider than the barrier ribs that are formed in both the others of the non-display and display regions. In this case, each barrier rib has a uniform line width.

Recently, in a high resolution PDP, as the size of a unit discharge cell has decreased, the line width of the barrier rib has also gradually decreased. However, when printing the phosphor layer on sides of the barrier rib, pressure is applied to the barrier rib.

Particularly, a narrower barrier rib that is located at the periphery of the PDP may not be able to withstand the pressure exerted on it during the phosphor printing process.

Therefore, while forming the phosphor layer, a narrower barrier rib that is located at the periphery of the PDP may be damaged.

### SUMMARY OF THE INVENTION

The present invention provides a plasma display panel with barrier ribs that may not be damaged when forming a phosphor layer.

Additional features of the invention will be set forth in the description which follows, and in part will be apparent from the description, or may be learned by practice of the invention.

The present invention discloses a PDP including a first substrate and a second substrate facing each other and including a display region for displaying images and a non-display region located at a periphery of the display region, a barrier rib arranged between the first substrate and the second substrate and forming discharge cells, an address electrode arranged between the first substrate and the second substrate and extending along a first direction, and a first electrode and a second electrode arranged in the discharge cells and extending along a second direction. A line width of the barrier rib in the display region is different from a line width of the barrier rib in the non-display region.

The present invention also discloses a barrier rib structure of a display panel including a first barrier rib having a first portion arranged in a non-display region and a second portion arranged in a display region. The first portion and the second portion are interconnected, and they have different widths.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view of a PDP according to an exemplary embodiment of the invention.

FIG. 2 is an enlarged exploded perspective view of a portion of the PDP of FIG. 1.

FIG. 3 is a cross-sectional view taken along line III-III of FIG. 2.

FIG. 4 is a cross-sectional view taken along line IV-IV of FIG. 2.

FIG. 5 is a plan view of a PDP according to another exemplary embodiment of the invention.

FIG. 6 is an enlarged exploded perspective view of a portion of the PDP of FIG. 5.

FIG. 7 is a cross-sectional view taken along line VII-VII of FIG. 6.

FIG. 8 is a cross-sectional view taken along line VIII-VIII of FIG. 6.

### DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Moreover, in the drawings, for convenience of explanation, portions having no relation to the invention will be omitted. Further, the same elements over the entire specification are represented by the same reference numerals.

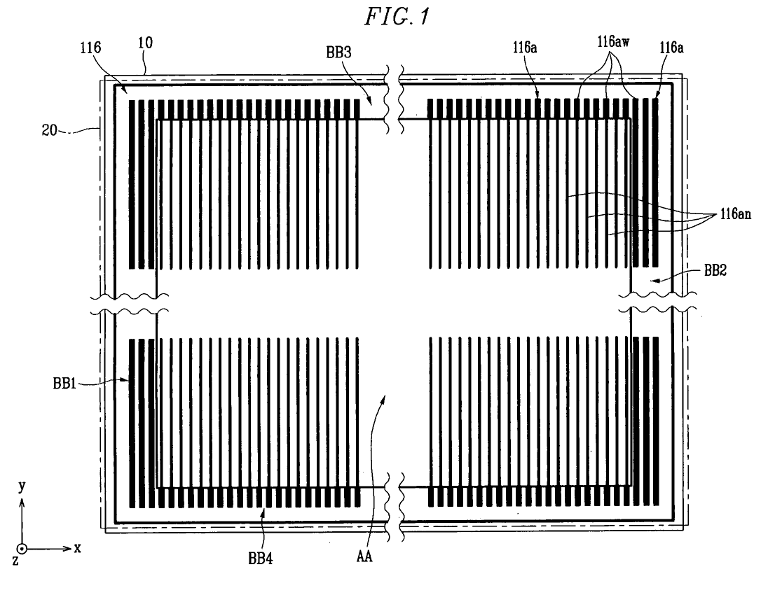

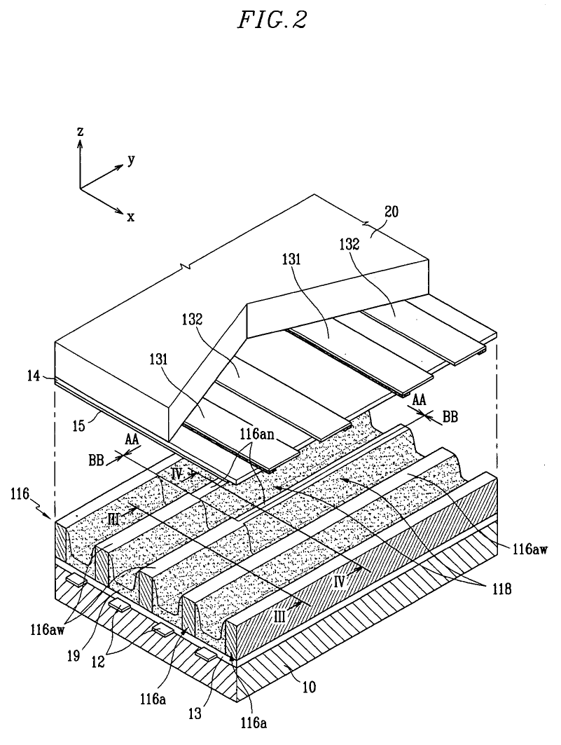

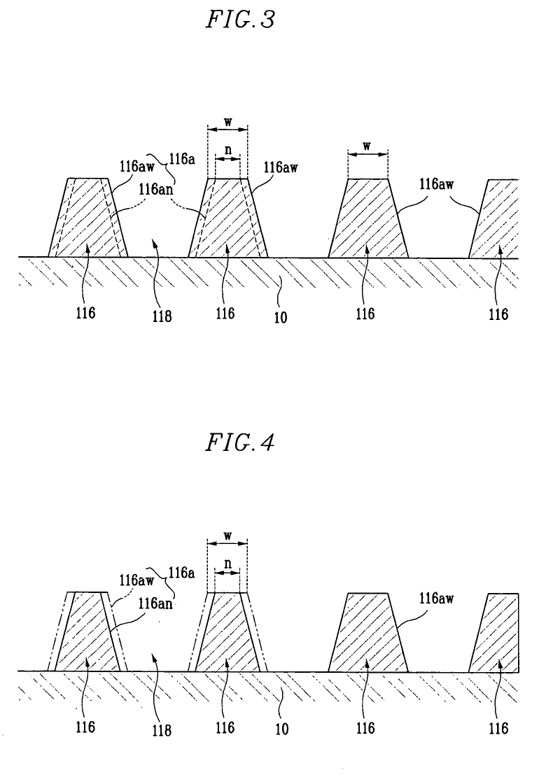

FIG. 1 is a plan view of a plasma display panel according to an exemplary embodiment of the invention, and FIG. 2 is an enlarged exploded perspective view of a portion of the PDP of FIG. 1. FIG. 3 and FIG. 4 are cross-sectional views taken along lines III-III and IV-IV of FIG. 2, respectively.

Referring to FIG. 1, FIG. 2, FIG. 3 and FIG. 4, a PDP according to an exemplary embodiment of the present invention may include a first substrate 10 (rear substrate), a second substrate 20 (front substrate) facing the rear substrate 10 with a predetermined gap therebetween, and a barrier rib 116 arranged between the rear substrate 10 and the front substrate 20. The barrier rib 116 partitions discharge cells 118.

A phosphor layer 19 is formed in the discharge cells 118 to absorb vacuum ultraviolet rays and emit visible light. Further, a discharge gas (for example, a mixture including xenon (Xe) and neon (Ne) or the like) is filled in the discharge cells 118 so as to generate the vacuum ultraviolet rays by a plasma discharge.

Address electrodes 12, first electrodes 131 (sustain electrodes), and second electrodes 132 (scan electrodes) are provided between the rear substrate 10 and the front substrate 20 so as to correspond to the respective discharge cells 118.

The address electrodes 12, the sustain electrodes 131, and the scan electrodes 132 may be formed with various structures, and they may have various arrangements. For example, the address electrodes 12, the sustain electrodes 131, and the scan electrodes 132 may be formed between the rear substrate 10 and the front substrate 20, and they may be arranged on either the rear substrate 10 or the front substrate 20, or they may be arranged on both substrates.

In the embodiment of FIG. 2, the address electrodes 12 are arranged on the rear substrate 10, the sustain electrodes 131 and the scan electrodes 132 are arranged on the front substrate 20, and the discharge cells 118 are provided therebetween.

The address electrodes 12 are formed on the rear substrate 10, and they extend along a first direction (y-axis direction). The address electrodes 12 are arranged at a predetermined interval along a second direction (x-axis direction) to correspond to the respective discharge cells 118.

A dielectric layer 13 covers the address electrodes 12. The dielectric layer 13 stores wall charges and protects the address electrodes 12 from being damaged during discharging.

Further, the sustain electrodes 131 and the scan electrodes 132 are formed on the front substrate 20, and they extend along the second direction (x-axis direction) to cross the address electrodes 12. Pairs of the sustain electrodes 131 and the scan electrodes 132 are arranged on both sides of respective discharge cells 118 along the y-axis direction so as to generate a surface-discharge.

Therefore, the scan electrode 132 is spaced apart from the address electrode 12 in a z-axis direction, and it crosses the address electrode 12 with respect to an x-y plane. During an address period, when a signal voltage is respectively applied to a scan electrode 132 and an address electrode 12, the corresponding discharge cell 118 is selected to be turned on from among all discharge cells 118.

During a sustain period, which follows the address period, when a signal voltage is alternately applied to the sustain electrodes 131 and the scan electrodes 132, the discharge cells 118 that were selected in the address period display images.

A dielectric layer 14 covers the sustain electrodes 131 and the scan electrodes 132 in order to form and store wall charges. A protection layer 15 covers the dielectric layer 14.

The protection layer 15 may be formed of a transparent material such as magnesium oxide (MgO). The protection layer 15 protects the dielectric layer 14 from the plasma discharge, and it increases a secondary electron emission coefficient during the plasma discharge.

The barrier rib 116 is formed protruding toward the front substrate 20, and it partitions the discharge cells 118. The discharge cells 118 are selected by an address discharge between the address electrode 12 and the scan electrode 132, and then the selected discharge cell 118 displays images by the sustain discharge, which follows the address discharge, between the sustain electrode 131 and the scan electrode 132.

The barrier rib 116 forms the discharge cells 118 in a display region AA, on which images are displayed, and in a non-display region BB, which is formed at the periphery of the display region AA so as to not display images thereon.

In a process of manufacturing the PDP, the phosphor layer 19 is disposed on sides of the barrier rib 116. That is, when the dielectric layer 13 is included, the phosphor layer 19 is arranged on an inner surface of the barrier rib 116 and a surface of the dielectric layer 13 that is not covered by the barrier rib 116.

As mentioned above, there are many methods that may be used to form the barrier rib 116 and the phosphor layer 19. For example, the barrier rib 116 may be formed through sandblasting, and the phosphor layer 19 may be formed by a printing method.

Regardless of the method used, since the phosphor layer 19 is formed on sides of the barrier rib 116, the barrier rib 116 is subject to the action for forming the phosphor layer 19.

The printing method may include arranging a screen mask on the barrier rib 116 and applying pressure to a phosphor paste on the screen mask so that the phosphor paste passes through the screen mask and is printed on sides of the barrier rib 116, thereby forming the phosphor layer 19. Accordingly, the barrier rib 116 is subject to the pressure applied to the phosphor paste.

In a high resolution PDP, the barrier rib may be formed with a uniform line width that is less than 60 micrometers. In such a case, the barrier rib at the periphery of the PDP may be vulnerable to the pressure applied to the phosphor paste.

Therefore, in the PDP according an exemplary embodiment of the present invention, the barrier rib 116 has a different width in the display region than in a non-display region. Hence, the barrier rib 116 may be utilized in a high resolution PDP, and it may also withstand the pressure applied when forming the phosphor layer. Consequently, the barrier rib 116 may not be damaged when forming the phosphor layer 19.

As described below, a wide line width of the barrier rib 116 may be a line width that is greater than about 60 micrometers, and a narrow line width may be a line width that is less than about 60 micrometers. However, the wide line width and the narrow line width are not limited to these values, since they are relative terms.

That is, in a PDP according to an exemplary embodiment of the present invention, the line width of the barrier rib 116 formed in the display region AA is narrower than the line width of the barrier rib 116 formed in the non-display region BB.

Accordingly, the ratio (w/n) of the line width (w) of the barrier rib 116 formed in the non-display region BB to the line width (n) of the barrier rib 116 formed in the display region AA is greater than 1.

The display region AA is formed in a central portion of the PDP, and the non-display region BB is formed at the periphery of the display region AA.

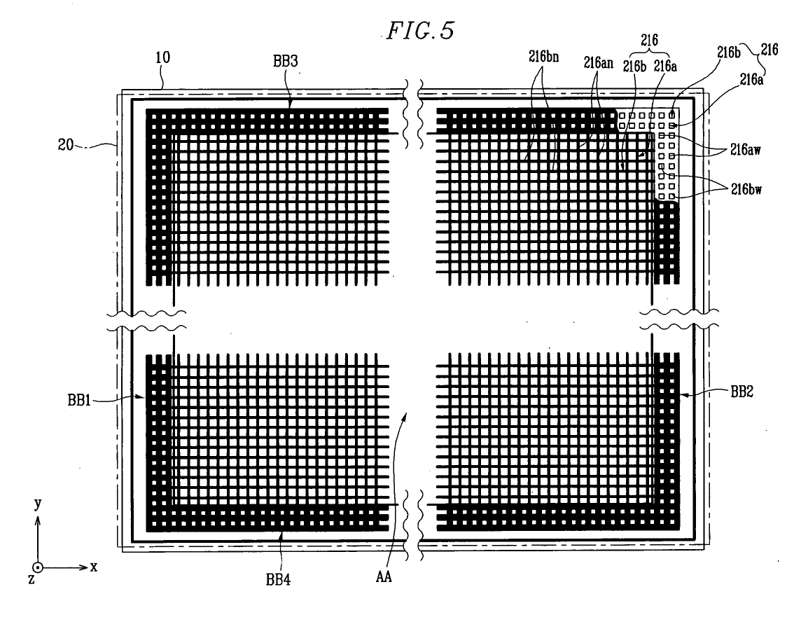

A wide barrier rib includes the wide barrier ribs 116aw in the embodiment of FIGs. 1 to 4 and the wide barrier ribs 216aw and 216bw in the embodiment of FIGS. 5 to 8, and a narrow barrier rib includes narrow barrier ribs 116an in the embodiment of FIGS. 1 to 4 and narrow barrier ribs 216an and 216bn in the embodiment of FIGS. 5 to 8.

The rear substrate 10 and the front substrate 20 have a substantially rectangular shape that has two short sides (both in the x-axis direction) and two long sides (both in the y-axis direction).

The non-display region BB includes non-display regions BB1 and BB2 located on the two short sides and non-display regions BB3 and BB4 located on the two long sides (see FIG. 1). For simplicity, the non-display region is referred to as BB in FIG. 2, and is referred to as BB1, BB2, BB3, and BB4 according to respective locations in FIG. 1.

The barrier rib 116 that is arranged entirely in the non-display regions BB1 and BB2 comprises the wide barrier ribs 116aw. On the other hand, the barrier rib 116 that is arranged in the non-display regions BB3 and BB4 and the display region AA comprises a wide barrier rib portion 116aw in the non-display region BB3, a wide barrier rib portion 116aw in the non-display region BB4, and a narrow barrier rib 116an coupling the wide barrier rib portions 116aw of the non-display regions BB3 and BB4.

The wide barrier ribs 116aw are able to better withstand the pressure applied when forming the phosphor layer 19, thereby preventing damage to the barrier rib 116.

The above construction and arrangement of the wide barrier ribs 116aw and the narrow barrier rib 116an may be applied regardless of the shape of the discharge cell 1118 that is formed by the barrier rib 116.

Hereinafter, the aforementioned barrier rib 116, which forms the discharge cell 118 of a stripe type, and the barrier rib 216, which forms the discharge cell 218 of a matrix type, will be exemplified.

In the embodiment shown in FIGS. 1 to 4, the barrier rib 116 comprises first barrier rib members 116a, which extend in the direction (y-axis direction) of the address electrodes 12 and are arranged at predetermined intervals along the x-axis direction to respectively correspond to the discharge cells 118.

The first barrier rib members 116a include the narrow barrier ribs 116an in the display region AA and the wide barrier ribs 116aw in the non-display region BB. The wide barrier ribs 116aw are wider than the narrow barrier ribs 116an.

More specifically, the first barrier rib members 116a formed entirely in the non-display regions BB1 and BB2 on the two short sides of the rear substrate 10 and the front substrate 20 comprise the wide barrier ribs 116aw.

On the other hand, each first barrier rib member 116a that traverses the display region AA comprises the wide barrier ribs 116aw formed in the non-display regions BB3 and BB4 on the two long sides and the narrow barrier rib 116an coupling the two wide barrier ribs 116aw on the long sides.

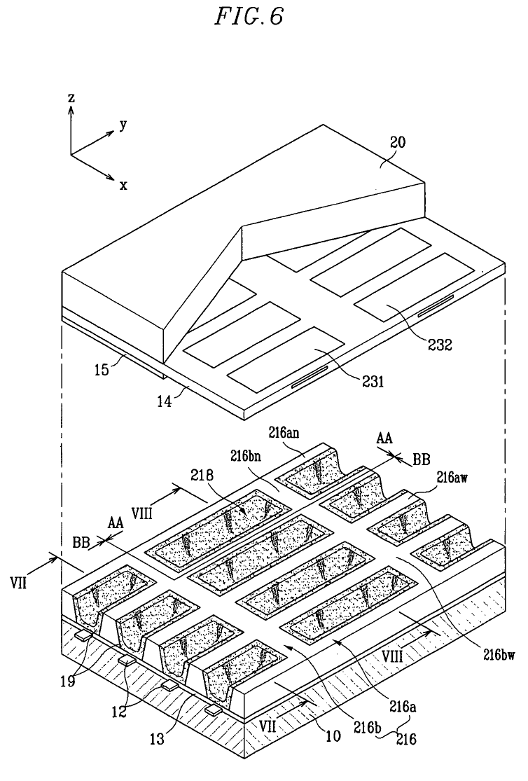

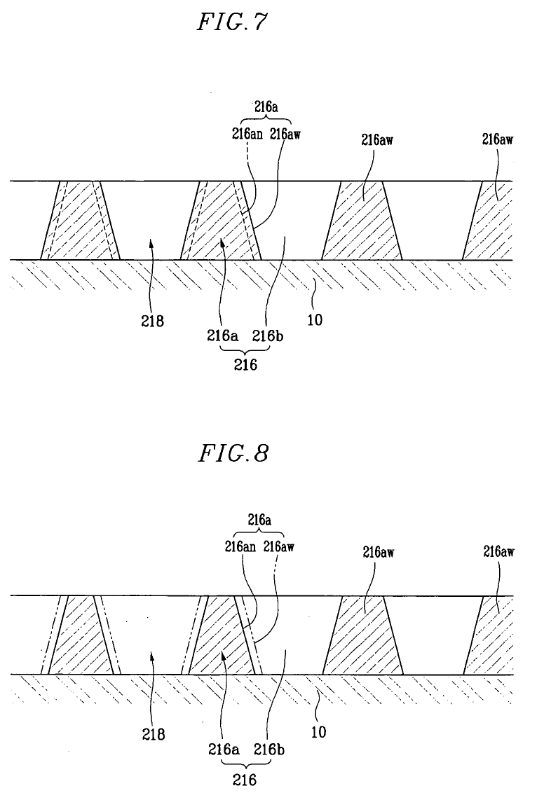

FIG. 5, FIG. 6, FIG. 7 and FIG. 8 show another exemplary embodiment of the invention, and the overall construction and operational effect is similar to that of the exemplary embodiment described above.

Referring to FIG. 5, FIG. 6, FIG. 7 and FIG. 8, the barrier rib 216 includes first barrier rib members 216a and second barrier rib members 216b.

The first barrier rib members 216a extend along the y-axis direction and are arranged at a predetermined interval along the x-axis direction to correspond to discharge cells 218. The second barrier rib members 216b extend along the x-axis direction to intersect the first barrier rib members 216a, and they are arranged at a predetermined interval along the y-axis direction to correspond to discharge cells 218.

The first barrier rib members 216a and the second barrier rib members 216b include the narrow barrier ribs 216an and 216bn formed in the display region AA and the wide barrier ribs 216aw and 216bw formed in the non-display region BB, respectively. The wide barrier ribs 216aw and 216bw are wider than the narrow barrier ribs 216an and 216bn.

More specifically, the barrier ribs 216 formed entirely in the non-display regions BB1 and BB2 on the two short sides of the rear substrate 10 and the front substrate 20 comprise the wide barrier ribs 216aw and 216bw.

On the other hand, the barrier ribs 216 that traverse the display region AA comprise the wide barrier ribs 216aw and 216bw in the non-display regions BB3 and BB4 on the two long sides and the narrow barrier ribs 216an and 216bn coupling the two wide barrier ribs 216aw and 216bw, respectively, on the long sides.

The sustain electrodes 131 and the scan electrodes 132 extend along the x-axis direction in the embodiment of FIGS. 1 to 4. On the other hand, the sustain electrodes 231 and the scan electrodes 232 extend along the x-axis direction while protruding in the y-axis direction at locations corresponding to the discharge cells 218.

According to embodiments of the invention, forming the line width of a barrier rib wider in the non-display region than in the display region may prevent the barrier rib from being damaged when forming the phosphor layer using a printing method.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate and a second substrate facing each other and including a display region for displaying images and a non-display region located at a periphery of the display region;
a barrier rib arranged between the first substrate and the second substrate and forming discharge cells;
an address electrode arranged between the first substrate and the second substrate and extending along a first direction; and
a first electrode and a second electrode arranged in the discharge cells and extending along a second direction,
wherein a line width of the barrier rib in the display region is different from a line width of the barrier rib in the non-display region.

2. The PDP of claim 1, wherein the barrier rib comprises a narrow barrier rib formed in the display region and a wide barrier rib formed in the non-display region, and the wide barrier rib is wider than the narrow barrier rib.

3. The PDP of claim 2, wherein the first substrate and the second substrate have a substantially rectangular shape having two shorter sides and two longer sides,
wherein the non-display region comprises a non-display region located on the two shorter sides and a non-display region located on the two longer sides, and
wherein the barrier rib located in the non-display region on the two shorter sides comprises the wide barrier rib.

4. The PDP of claim 3, wherein the barrier rib located between the wide barrier ribs on the two shorter sides comprises the wide barrier rib in the non-display region on the two longer sides and the narrow barrier rib coupling the two wide barrier ribs on the two longer sides.

5. The PDP of claim 1, wherein the barrier rib comprises first barrier rib members extending along the first direction and arranged at a predetermined interval along the second direction to correspond to the discharge cells.

6. The PDP of claim 5, wherein the first barrier rib members comprise narrow barrier ribs formed in the display region and wide barrier ribs formed in the non-display region, and the wide barrier ribs are wider than the narrow barrier ribs.

7. The PDP of claim 6, wherein the first substrate and the second substrate have a substantially rectangular shape having two shorter sides and two longer sides,
wherein the non-display region comprises a non-display region located on the two shorter sides and a non-display region located on the two longer sides, and
wherein the first barrier rib members located in the non-display region on the two shorter sides comprise the wide barrier ribs.

8. The PDP of claim 7, wherein the first barrier rib members located between the wide barrier ribs on the two shorter sides comprise the wide barrier ribs in the non-display region on the two longer sides and the narrow barrier ribs coupling the two wide barrier ribs on the two longer sides.

9. The PDP of claim 1, wherein the barrier rib comprises:
first barrier rib members extending along the first direction and arranged at a predetermined interval along the second direction to correspond to the discharge cells; and
second barrier rib members extending along the second direction and arranged at a predetermined interval along the first direction to correspond to the discharge cells.

10. The PDP of claim 9, wherein the first barrier rib members and the second barrier rib members comprise narrow barrier ribs formed in the display region and wide barrier ribs formed in the non-display region, and the wide barrier ribs are wider than the narrow barrier ribs.

11. The PDP of claim 10, wherein the first substrate and the second substrate have a substantially rectangular shape having two shorter sides and two longer sides,
wherein the non-display region comprises a non-display region located on the two shorter sides and a non-display region located on the two longer sides, and
wherein the first barrier rib members and the second barrier rib members located in the non-display region on the two shorter sides comprise the wide barrier ribs.

12. The PDP of claim 11, wherein the first barrier rib members and the second barrier rib members located between the wide barrier ribs on the two shorter sides comprise the wide barrier ribs in the non-display region on the two longer sides and the narrow barrier ribs coupling the two wide barrier ribs on the two longer sides.

13. The PDP of claim 1, wherein w is the line width of the barrier rib formed in the non-display region, n is the line width of the barrier rib formed in the display region, and a ratio of w/n is greater than 1.

14. A barrier rib structure of a display panel, comprising:
a first barrier rib including a first portion arranged in a non-display region and a second portion arranged in a display region,
wherein the first portion and the second portion are interconnected, and a line width of the first portion is different from a line width of the second portion.

15. The barrier rib structure of claim 14, further comprising:
a second barrier rib arranged in the non-display region,
wherein the first portion of the first barrier rib comprises a first end and a second end, and the second portion of the first barrier rib comprises an interconnecting portion coupling the first end with the second end, and
wherein the interconnecting portion of the first barrier rib has a different line width than at least one of the first end of the first barrier rib and the second end of the first barrier rib.

16. The barrier rib structure of claim 15, wherein the interconnecting portion of the first barrier rib is narrower than the first end of the first barrier rib and the second end of the first barrier rib, and the first end of the first barrier rib, the second end of the first barrier rib, and the second barrier rib have substantially the same line width.

17. The barrier rib structure of claim 16, wherein second barrier ribs are independently arranged in the non-display region.

18. The barrier rib structure of claim 15, further comprising:
a third barrier rib comprising a first end, a second end, and an interconnecting portion coupling the first end with the second end, and
a fourth barrier rib,
wherein the first end of the third barrier rib, the second end of the third barrier rib, and the fourth barrier rib are arranged in the non-display region, and the interconnecting portion of the third barrier rib is arranged in the display region, and
wherein the interconnecting portion of the third barrier rib has a different line width than at least one of the first end of the third barrier rib and the second end of the third barrier rib.

19. The barrier rib structure of claim 18, wherein the first barrier rib and the second barrier rib are arranged substantially in parallel with each other, and the third barrier rib and the fourth barrier rib are arranged substantially in parallel with each other, and
wherein the first barrier rib and the second barrier rib are arranged substantially orthogonal to the third barrier rib and the fourth barrier rib.

20. A plasma display panel comprising the barrier rib structure of claim 14.
